(19) United States
(12) Patent Application Publication
(10) Pub. No.: US 2011/0093323 A1
(43) Pub. Date: Apr. 21, 2011

(54) METHOD OF VALIDATING A DISCOUNT OFFER

(76) Inventors: David R. Prus, Casnovia, MI (US); Michael R. Holcomb, Byron Center, MI (US)

(21) Appl. No.: 12/582,412

(22) Filed: Oct. 20, 2009

(51) Int. Cl. G06Q 30/00

(52) U.S. Cl. 705/14.26; 705/14.38

(57) ABSTRACT

A method of validating a discount offer includes obtaining discount information from a coupon at a dispenser, the discount information including a unique discount identifier. The discount information is sent to a local controller, which attempts to communicate with a central system to validate the offer. If the central system is inaccessible, the local controller then compares the unique discount identifier with a local database of previously redeemed coupons. If the unique discount identifier is not found in the local database, the local controller approves the coupon and instructs the dispenser to reduce the amount charged to a customer by the discount amount. The local controller then adds the unique discount identifier to the local database. When the central server is again accessible, the redeemed discount identifiers are communicated from the local database to the central system.

### BACKGROUND OF THE INVENTION

The present invention generally relates to validating discount offers and coupons, and more particularly to validating discount offers that can be redeemed at multiple locations.

There is a growing trend for retailers to offer fuel dispensing facilities or gas stations at or near the retailer's locations or stores. The proximity of the gas station to the store makes it convenient for a customer to shop at both facilities. For example, grocery stores commonly include gas stations, quick stops or fuel marts on their premises.

Retailers have also discovered that it is helpful to provide an incentive to customers to visit both the retail facility and the gas station. For example, some retailers provide customers with a chit that includes a bar code encoded with a discount amount. The chit can be issued to the customer based on a variety of criteria, including the dollar amount of the customer's purchase, the purchase of a certain number of particular products, or accumulation of a certain number of loyalty points. The purchaser can then take the chit to the gas station and scan the bar code at the fuel dispenser, which either reduces the price per unit charged to the customer for fuel or reduces the total amount charged to the customer. Often, the gas station will have multiple locations at which the chit can be redeemed.

In some systems, a bar code reader on the fuel dispenser reads discount information from the bar code and sends it to a local controller, which then sends it to a central system for validation. For example, the discount information may include a discount amount, an expiration date and a chit identifier. The central system will then compare the chit identifier against a central database containing identifiers associated with chits that have already been redeemed, to ensure that the chit has not previously been used at any of the gas station locations. If the central system determines that the chit has not been used, the central system will validate the chit.

Problems can arise when the central server is down or otherwise inaccessible, because the local controller cannot check the chit identifier against the central database and, thus, cannot determine whether the chit has already been used. Retailers typically program the local controller to issue the discount anyway, which may result in losses if discount offers are reused.

### SUMMARY OF THE INVENTION

The present invention provides a system and method of validating a discount offer that can prevent reuse of the offer at a particular retailer location even if the central server is inaccessible.

According to one aspect, a method of validating a discount offer includes obtaining discount information from a coupon at a dispenser, the discount information including a unique discount identifier. The method includes sending the discount information from the dispenser to a local controller, which attempts to communicate with a central server and determines whether the central server is inaccessible. If the server is inaccessible, the local controller then compares the unique discount identifier against a local database containing identifiers associated with previously used coupons. If the unique discount identifier is not found in the local database, the local controller sends a message of approval to the dispenser to reduce the amount charged to a customer by the discount amount. The local controller then adds the unique discount identifier to the local database. In the current embodiment, the identifiers in the local database are communicated to the central server after the server becomes accessible.

Thus, the present invention provides a way to prevent reusage of a discount offer at a particular store location, even when the system is unable to communicate with a central system to validate the offer. The system and method described herein allow a local controller to verify that a discount offer has not yet been used at that particular location and optionally verify that is has not yet expired.

These and other features of the invention will be more fully understood and appreciated by reference to the description of the embodiments and the drawings.

### BRIEF DESCRIPTION OF THE DRAWINGS

FIG. 1 is a block diagram of one embodiment of a system for validating a discount offer in accordance with the present invention.

FIG. 2 illustrates a representative diagram of the system of FIG. 1.

FIG. 3 is another block diagram of a system of issuing and validating a discount offer in accordance with an embodiment of the present invention

FIG. 4 is a flow chart of a method of validating a discount offer.

### DESCRIPTION OF THE EMBODIMENTS

### I. System

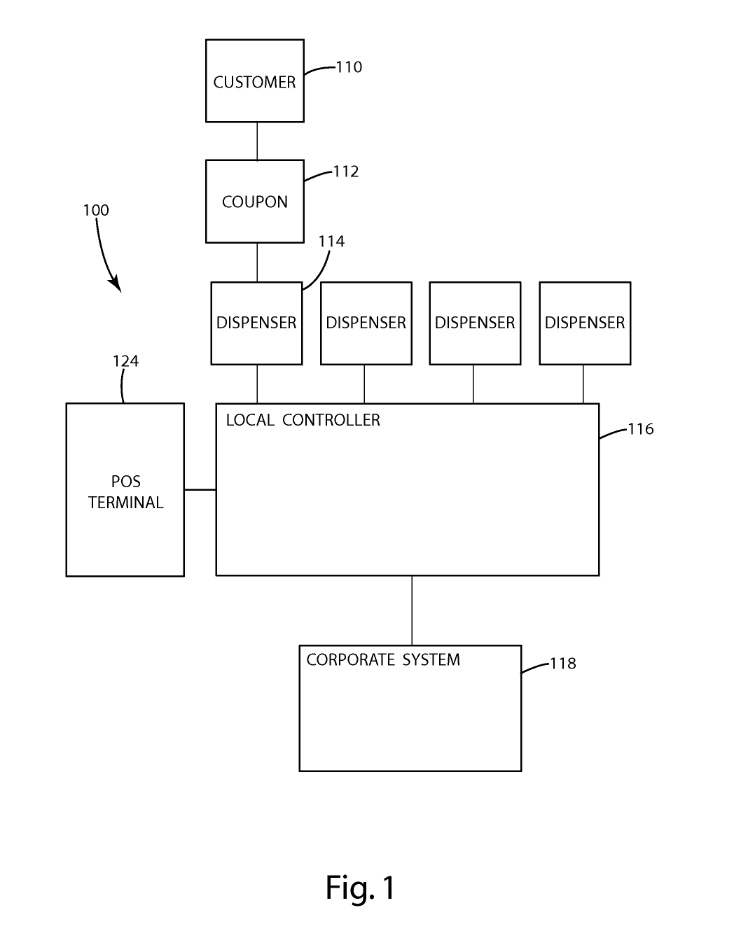

A system adapted to validate a discount offer in accordance with an embodiment of the present invention is shown in FIGS. 1-3 and is generally designated 100. The system includes a customer 110 that has received a coupon 112 for a discount on a product that is dispensed from a dispenser 114. The dispenser 114 is adapted to obtain discount information from the coupon 112, the discount information including a unique discount identifier, an expiration date and a discount amount. The dispenser 114 is also adapted to send the discount information to a local controller 116, which is adapted to communicate with a central system 118. The local controller 116 sends at least the unique discount identifier to a central system 118, which is adapted to compare the discount identifier against a central database of identifiers associated with previously used coupons, to determine whether the coupon has been previously redeemed. When the central system 118 is inaccessible, the local controller 116 is adapted to compare the expiration date against the current date to ensure that the discount offer has not expired. If the expiration date is the same as or later than the current date, then the local controller 116 is adapted to compare the unique discount identifier against a local database of identifiers associated with coupons that have previously been redeemed at that particular location. In some embodiments in which the discount offer is not associated with an expiration date, the comparison of expiration dates can be skipped, such that the local controller compares only the discount identifiers or compares the discount identifiers and other optional information. If the unique discount identifier is not found in the local database, the local controller 116 is adapted to validate the discount offer by instructing the dispenser 114 to dispense the product at a price discounted by the discount amount.

The customer 110 can obtain the coupon 112 in a variety of ways. For example, the customer may have received the coupon 112 as a result of a previous purchase made at the dispenser 114. Optionally, the dispenser 114 can be associated with a fuel center or gas station 117 that includes a quick stop or convenience store. In such an embodiment, the customer 110 may receive a coupon 112 as a result of a purchase made in the quick stop or convenience store.

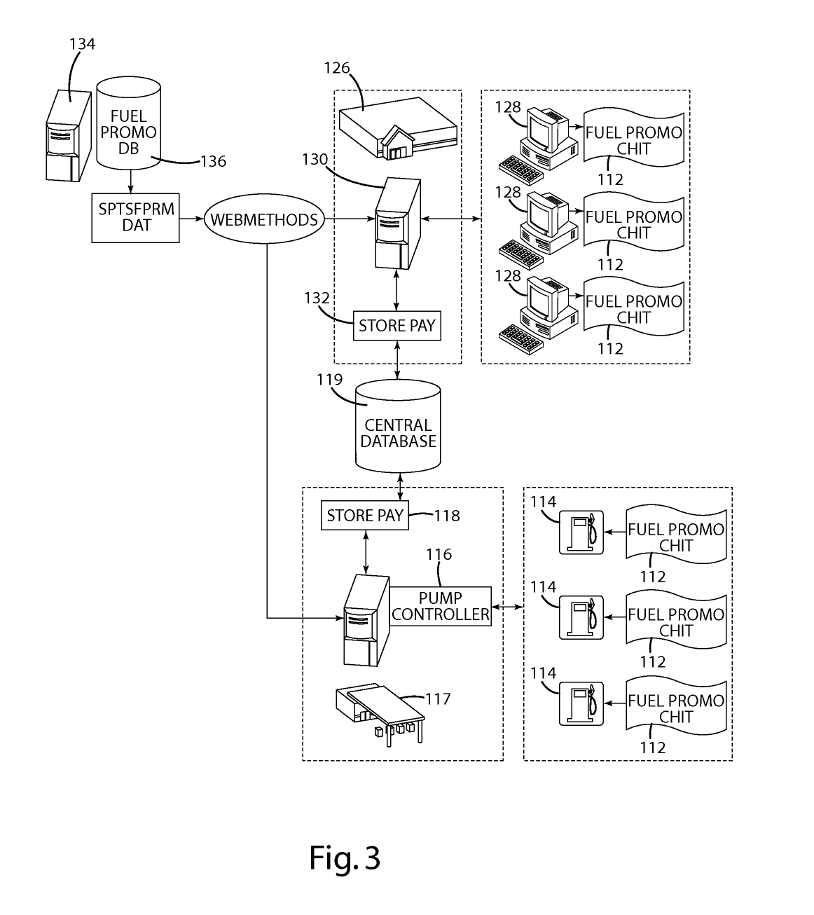

Alternatively, the gas station 117 can be associated with an unrelated retail store, such as a grocery store 126 (FIG. 3). Although the retail store is shown in the illustrated embodiment as a grocery store 126, the retail store could alternatively be a store in a shopping mall, a discount warehouse store, home improvement store or any other type of store unrelated to gas stations. Customers of the grocery store 126 could receive a coupon 112 as a result of purchases made at that store. For example, the store 126 may issue a coupon 112 to a customer 110 in exchange for the customer's purchase of goods totaling a certain dollar amount, or for the purchase of a certain number of particular products. As a specific example, a grocery store 126 may offer a promotion in which customers receive a $0.20 per gallon discount on fuel at the gas station 117 in exchange for either a total purchase of $50.00 in the grocery store or the purchase of 10 particular grocery store items. Alternatively, the store may have a customer loyalty program, in which the customer receives the coupon 112 in exchange for the accumulation of a certain number of loyalty points or the like. Loyalty points can similarly be accumulated based on a total purchase amount or the purchase of particular products.

The grocery store 126 may include a grocery store controller 130 adapted to control a set of cash registers or point of service (POS) terminals 128 located in the grocery store 126 (FIG. 3). The grocery store controller 130 can also control the issuance of the coupons 112. For example, when the customer 110 checks out at a POS terminal 128 at the grocery store 126 and makes a qualifying purchase as discussed above, the grocery store controller 130 can send a request to a promotions server 134, which can be programmed to issue coupons in response to requests from the grocery store controller 130. The promotions server 134 may be situated locally, at that particular grocery store 126. In an embodiment in which each grocery store 126 includes an individual promotions server 134, the promotions server 134 can optionally be programmed to offer discounts tailored to the customers of a particular store. Alternatively, the promotions server 134 may be located at a remote location, such as a corporate headquarters. In such an embodiment, the promotions server 134 may offer the same types of discounts to customers at all of the grocery stores 126.

The promotions server 134 can be programmed to compare the customer's purchase to the coupon requirements to ensure that the customer 110 earned the coupon. Optionally, the promotions server 134 can include a coupon database 136 from which to select a coupon 112 to issue to the customer 110. The coupon database can include any number of different discount offers, including discounts on fuel at the gas station 117. Once a discount offer is selected and the coupon 112 issued to the customer, the grocery store controller 130 sends information associated with the coupon 112, including a unique discount identifier, to the central system 118 for storage and later activation, which will be discussed in more detail below.

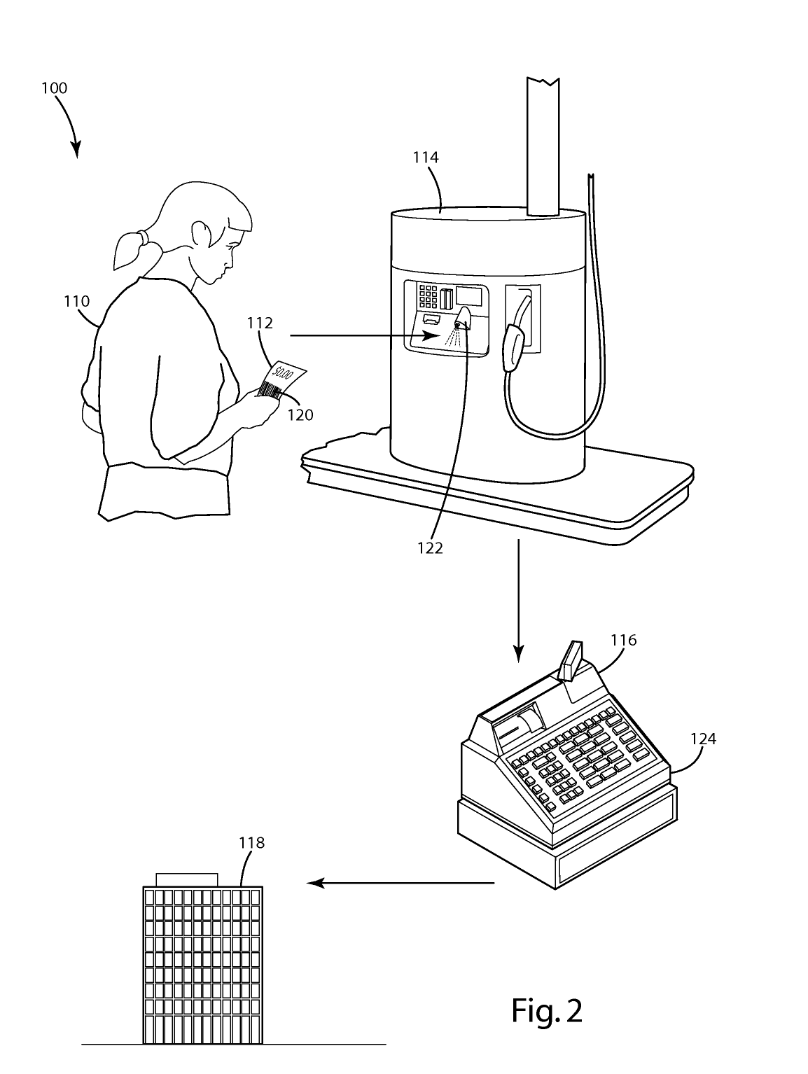

The coupon 112 can be issued in any suitable form adapted to store and transfer discount information to the dispenser 114. In the illustrated embodiment, the coupon 112 is a receipt or chit issued by a cash register or POS terminal 128 in the grocery store 126, as discussed above. As shown in FIG. 2, the chit 112 includes a unique bar code 120, containing the discount information associated with the discount offer. The dispenser 114 can include a bar code reader 122 adapted to scan the bar code 120 to obtain the discount information. In an embodiment in which the coupon 112 is a chit having a bar code, the discount information can be encoded in the bar code in a 28 digit code. For example, the 28 digits can store information including, but not limited to, the location of the store 126, the lane number where the coupon was issued, the date the coupon was issued, the POS terminal 128 transaction number, the maximum number of gallons of gas to be discounted, the price per gallon discount, the number of multiple discount slips that were issued in association with a particular transaction, the number associated with the promotion, and the duration or length of the promotion. For example, the 28 digits could be “1234121012145674002002567814” and could be coded as shown in the table below:

| | | | | Maximum | | | | |
|---|---|---|---|---|---|---|---|---|
| | | | | Gallons to | | # of | | Duration |
| | | Date | POS | be | PPG | multiple | | of the |
| Store # | Lane # | Issued | Transaction # | Discounted | Discount | slips | Promotion # | promotion |
| 1234 | 12 | 10121 | 4567 | 40 | 0.20 | 02 | 5678 | 14 |

The category for “# of multiple slips” designates the number of slips that were printed during a particular transaction. While the POS terminal 128 typically generates one coupon 112 for each customer, more than one coupon 112 may be generated, for example, if the printer becomes jammed or otherwise disabled, or if the system encounters another type of error. Multiple slips may also be printed by a manager for distribution to customers as a marketing promotion, even if the customers have not reached the required purchasing threshold or number of loyalty points. In either case, the grocery store controller 130 records the number of coupons 112 that are printed and approves each of the slips for use.

Alternatively, the coupon 112 can be a card having a magnetic strip that can be swiped at a card reading device on the dispenser 114. For example, the card can be a customer loyalty card or a credit or debit card. In such an embodiment, discount information, such as the items described above, can be encoded in the magnetic card. In another embodiment, the coupon 112 can be in the form of any suitable electronic device adapted to communicate with the dispenser 114 when the device comes within a certain distance of the dispenser 114.

The dispenser 114 can be adapted to dispense any suitable product for purchase by customers. In the illustrated embodiment, the dispenser 114 is a standard fuel pump and is adapted to dispense fuel into customers' vehicles. As discussed above, in the illustrated embodiment, the dispenser 114 includes a bar code reader 122 mounted to the front of the pump and can alternatively include any reader or scanner or other suitable device that is adapted to communicate with and obtain information from the coupon 112. Alternatively, the system 100 may be adapted to provide discount offers to customers on products that need not be dispensed from a dispenser 114. For example, the coupon 112 may also be adapted to be redeemed at a traditional cash register or POS terminal.

The local controller 116 is adapted to control the dispenser 114. For example, the local controller 116 can control the amount of fuel dispensed from the dispenser 114 and the price per unit (PPU) at which fuel is dispensed. Optionally, the local controller can control multiple dispensers 114 at a particular location. For example, a typical gas station may have as many as eight or more dispensers. The local controller 116 can individually control each of the dispensers at a particular location.

The local controller 116 may include memory, which can include a local database adapted to store the discount identifiers associated with coupons 112 that have been redeemed at that particular location. The local controller 116 can be programmed to compare a new unique discount identifier that a customer is attempting to use with those stored in the local database, to ensure that the coupon 112 has not been previously used.

The local controller 116 can optionally be associated with or connected to a cash register or point of service (POS) terminal 124. For example, in an embodiment that includes a convenience store, both the POS terminal 124 and the local controller 116 can be located in the convenience store. The convenience store, POS terminal 124 and local controller 116 can be located proximate to the dispensers 114, for example, within a distance that a customer would be comfortable walking. The POS terminal 124 in the convenience store can be a standard cash register adapted to accept payment from customers. For example, customers paying with cash or a check may need to go inside the convenience store to pay for fuel if the dispensers 114 are not adapted to receive these types of payments. Optionally, the POS terminal 124 can be adapted to read information from the coupon 112 so that a customer 110 can redeem the coupon in the convenience store, as opposed to at the dispenser 114. For example, the POS terminal 124 can include a bar code scanner or a card reader.

The central system 118 can be any suitable computer or other device that processes validation requests and delivers data to other computers or controllers over a network or the Internet, For example, the central system 118 could be a corporate server or a web server. 111 the illustrated embodiment, the central system 118 is adapted to receive and process requests from the local controller 116. Optionally, the central system 118 can be adapted to receive and process requests from multiple local controllers 116 located at a variety of gas stations 117.

The central system 118 can include memory, which can include a central database 119 adapted to maintain the status of the discount identifiers associated with the coupons in the system. The status may be “approved,” “redeemed” or “expired.” In the illustrated embodiment, the central system 118 is programmed to compare a discount identifier that a customer is attempting to use with the central database 119 to ensure that the status of the coupon 112 is not “redeemed” or “expired.” However, unlike the local controller 116, which can only determine whether the coupon has been redeemed at that particular location, the central system 118 can determine whether the coupon has been redeemed at any of the gas station locations.

The central system 118 can be located any distance from the local controller 116 and dispenser 114. For example, the central system 118 can be located at a corporate headquarters building located in another city or state. As noted above, the central system 118 can be adapted to communicate with multiple local controllers 116, each of which are adapted to control a set of dispensers 114 at a particular gas station 117. In such an embodiment, the central database 119 stores the unique identifiers associated with all of the coupons 112 that have been redeemed at all of the gas stations 117.

### II. Method

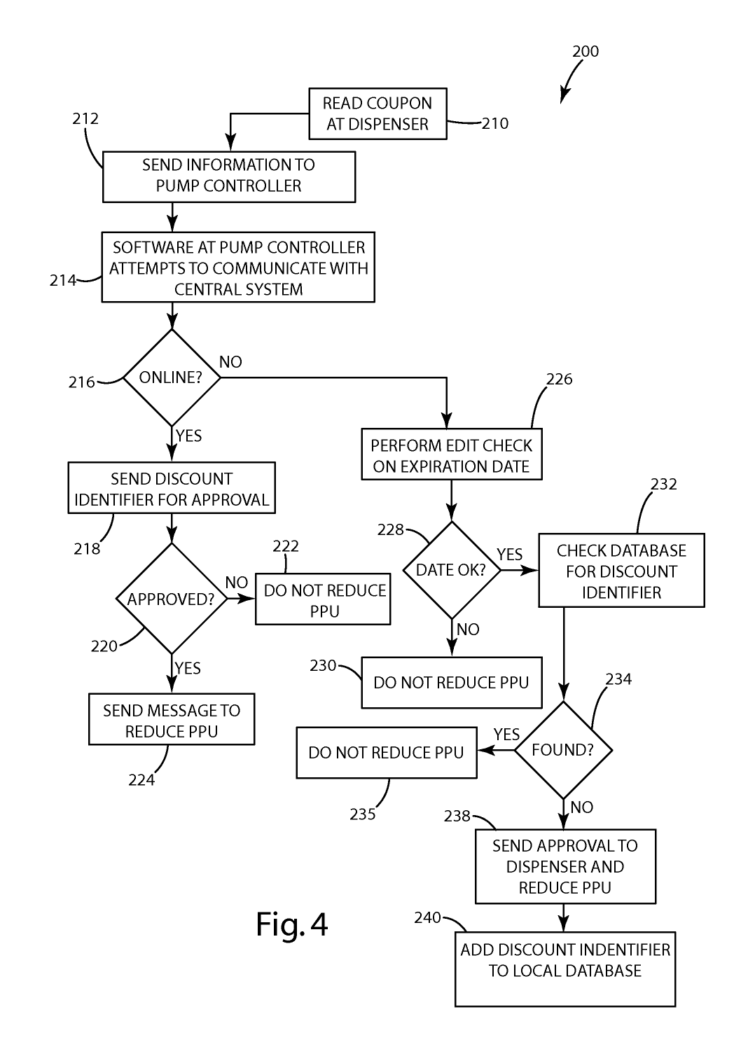

A method 200 of validating a discount offer using the system 100 described above is shown in the flowchart of FIG. 4. The method 200 includes the step of engaging the coupon with the dispenser so that the dispenser can read the discount information from the coupon 210. For example, if the coupon is a chit having a bar code, the customer can hold the coupon under the bar code scanner on the dispenser so that the scanner can read the discount information from the chit. Alternatively, this step 210 may include swiping a card having a magnetic strip through a card reader located on the dispenser or holding an electronic card against a feature on the dispenser that is adapted to communicate with the card. The discount information obtained from the coupon includes, but is not limited to, the coupon's expiration date, a unique discount identifier and a discount amount.

The method 200 further includes the step of sending the discount information from the dispenser to the local controller 212. The local controller then attempts to communicate with the central system to validate the discount offer 214. For example, the local controller can attempt to communicate with the central system through a local server via a router or dedicated circuit or network connection. If the central system is online or otherwise accessible, the local controller sends a request to the central system to (a) check the central database to ensure that the unique discount identifier associated with the coupon is not in the database, to ensure that the discount offer has not been previously redeemed; and (b) send a message back to the local controller either validating or rejecting the discount offer 216, 218. Regardless of whether the central system is accessible, the local controller can optionally record the identifier in the local database.

In response to the request from the local controller, the central system compares the unique discount identifier against the identifiers stored in the central database. When the central system finds the unique identifier in the database, the central system checks the status of the identifier, which will be one of the following: i) approved, ii) redeemed, or iii) expired. If the status is “redeemed” or “expired,” the system rejects the coupon and sends a message to the local controller to instruct the dispenser not to dispense fuel at a discounted rate 220, 222. Optionally, the dispenser can display a message to the customer stating why the coupon was rejected. If the central system determines that the status of the unique identifier is “approved,” thus indicating that the coupon has not been previously redeemed, the central system sends a message of approval to the local controller to validate the coupon. In response to the message of approval from the central system, the local controller then instructs the dispenser to dispense fuel at a price discounted by the discount amount associated with the coupon 224. The discount amount can optionally be a price per unit (PPU) discount or a discount applied to the customer's total purchase.

In certain situations, after the local controller sends the request to the central system, the central system may be unable to locate the unique discount identifier. This may occur, for example, if the customer attempts to redeem the coupon before the grocery store controller uploads the unique discount identifier associated with the coupon to the central system. Typically, the grocery store controller uploads the identifier immediately, but a delay may occur if either the POS terminal or the grocery store controller were offline or otherwise unable to communicate with the central system when the coupon was issued. In either of these situations, the grocery store controller will continuously attempt to regain access to the central system, for example, every 30 seconds. The unique discount identifier will be uploaded to the central system as soon as the grocery store controller regains access. The system can be programmed so that the coupon will be approved for use even when the unique discount identifier is not found in the central system.

However, the local system may be unable to communicate with the central system, for example, because it is offline or because the network or circuit connection between the local controller and the central system is down or broken. If the central system is offline or otherwise inaccessible from the local controller, the local controller can perform at least some of the functions that would normally be performed by the central system. For example, in the illustrated embodiment, the local controller either verifies that the status of the coupon is not “expired” or compares the expiration date of the coupon with the current date to ensure that the coupon has not expired 226. If the status is “expired,” or if the current date is later than the expiration date, the local controller instructs the dispenser to reject the coupon and not to apply the discount to the customer's purchase 228, 230.

If the current date is the same as or earlier than the expiration date, the local controller checks the local database for the unique discount identifier 232, to ensure that the chit has not been previously redeemed at a dispenser at that particular location. If the chit identifier is found in the local database and if the status is “redeemed,” then the local controller instructs the dispenser to reject the coupon and not to dispense fuel at a discounted price 234, 236. If the chit identifier is found in the local database and the status is “approved,” the local controller sends a message of approval to the dispenser to reduce the amount charged to the customer by the discount amount associated with the chit 238. The local controller then changes the status of the unique discount identifier from “approved” to “redeemed.”

If the discount offer is applied, the local controller then adds the coupon identifier to the local database 240, which allows the local controller to detect a customer's attempt to reuse that coupon at that particular gas station location, even when the central system is inaccessible. For example, if a customer were to drive back to the same gas station and scan the coupon at either the same dispenser or any other dispenser at that particular gas station, all of which are controlled by the same local controller, all of the steps of the method 200 described above would be repeated. However, when the local controller checks the local database for the unique discount identifier 232, the local controller would identify the unique chit identifier in the local database, and would therefore reject the coupon. If the coupon is rejected, the local controller may display a message at the dispenser explaining why the coupon was rejected.

Optionally, once the central system again becomes accessible, the local controller can transmit the stored unique discount identifiers, which have been redeemed since the central system was inaccessible, to the central database. Thus, the next time a customer would attempt to reuse a coupon having one of the discount identifiers, the central system would identify the unique chit identifier in the central database and determine that the status is “redeemed.” As a result, the discount offer associated with that coupon would be rejected. To help ensure that the identifiers of all redeemed coupons will be added to the central system as soon as possible, the local controller can optionally be adapted to automatically attempt to communicate with the central system continuously, or every 30 seconds, for example. Optionally, the discount identifiers associated with the redeemed coupons can be stored in a “stored and forward” file in the local database, the contents of which are automatically transferred to the central system upon reconnection with the local controller. Once the contents of the “stored and forward” file are transferred to the central system, the local database may be purged.

While this system will prevent a discount coupon from being reused at a particular, first location, it could allow a coupon to be redeemed at a second location or other multiple locations while the central system is down. The coupon could be redeemed at other locations because neither the local controllers at that those locations nor the central system will be aware that the coupon has been redeemed at the first location. However, after the identifiers from the local database at the first location are transferred to the central system, the system will prevent use of the coupons associated with those identifiers at all locations.

The above description is that of current embodiments of the invention. Various alterations and changes can be made without departing from the spirit and broader aspects of the invention as defined in the appended claims, which are to be interpreted in accordance with the principles of patent law including the doctrine of equivalents. Any reference to claim elements in the singular, for example, using the articles “a,” “an,” “the” or “said,” is not to be construed as limiting the element to the singular.

The embodiments of the invention in which an exclusive property or privilege is claimed are defined as follows:

1. A method of validating a discount offer on a product, comprising:
obtaining discount information from a coupon at a dispenser adapted to dispense the product, the dispenser located at a first location, wherein the discount information includes a unique discount identifier and a discount amount;
sending the discount information to a local controller located at the first location, said local controller adapted to control the dispenser, wherein the local controller includes a local database adapted to store identifiers associated with previously redeemed coupons;
attempting to communicate with a central system to validate the coupon;
in response to the attempting to communicate being unsuccessful, attempting to locate the unique discount identifier in the local database to determine whether the coupon has been redeemed;
in response to the attempting to locate revealing that the unique discount identifier has not been redeemed, sending a message to the dispenser to approve the discount offer;
reducing an amount charged to the customer by the discount amount; and
adding the redeemed unique discount identifier to the local database.

2. The method of claim 1 further including controlling a plurality of dispensers at the first location with the local controller.

3. The method of claim 2 further including, after the step of adding the redeemed unique discount identifier to the local database:
presenting the coupon at one of the plurality of dispensers at the first location;
obtaining the discount information from the coupon;
sending the discount information to the local controller;
attempting to communicate with the central system;
in response to the attempting to communicate being unsuccessful, attempting to locate the unique discount identifier in the local database to determine whether the coupon has been redeemed; and
finding the redeemed unique discount identifier in the local database.

4. The method of claim 3 further including, after the step of finding the redeemed unique discount identifier in the local database, sending a message to the dispenser to reject the coupon and not to reduce an amount charged to the customer by the discount amount.

5. The method of claim 4 wherein the central system includes a central database, wherein the method further includes communicating with the central system after the central system becomes accessible and at least one of adding the redeemed unique discount identifier to the central database and changing the status of the unique discount identifier to redeemed.

6. The method of claim 5 wherein the discount information includes an expiration date, wherein the method includes comparing the expiration date to the current date.

7. The method of claim 1 wherein obtaining discount information from a coupon includes one of swiping a card having a magnetic strip through a card reader and scanning a chit having a bar code with a bar code scanner.

8. The method of claim 1 wherein the central system is located at a second location remote from the first location, wherein attempting to communicate includes attempting to communicate through at least one of a network connection and an internet connection.

9. The method of claim 1 further including issuing the coupon to the customer at a retail location in exchange for at least one purchase made by the customer at the retail location.

10. The method of claim 9 wherein the retail location is a grocery store and wherein the first location is a gas station, wherein the method includes dispensing fuel from the dispenser.

11. The method of claim 2 wherein multiple local controllers each control a plurality of dispensers at multiple locations, wherein the method includes communicating with the central system by each of the local controllers.

12. A method of validating a discount offer on fuel, comprising:
issuing a coupon to a customer at a retail location and associating discount information with the coupon, the discount information including at least an expiration date, a unique discount identifier, a discount amount and a status, wherein the status is approved;
transferring the discount information to a central system;
obtaining the discount information from the coupon at a fuel dispenser located at a first fuel dispensing location;
storing identifiers associated with coupons redeemed at the first fuel dispensing location in a local database;
sending the discount information to a local controller located at the first fuel dispensing location, wherein the local controller is adapted to control the fuel dispenser and access the local database;
attempting to communicate with the central system to check the status of the coupon;
in response to the attempting being unsuccessful, checking the expiration date, wherein a current date is at least the same as or earlier than the expiration date; and
comparing the unique discount identifier with the identifiers in the local database; and
in response to the comparing indicating that the unique discount identifier is not included in the database, sending a message to the fuel dispenser to approve the discount offer, reducing an amount charged to the customer by the discount amount, changing the status of the coupon to redeemed and adding the identifier associated with the redeemed coupon to the local database.

13. The method of claim 12 further including controlling a plurality of dispensers at a first location with the local controller and, after the step of adding the identifier to the local database:
presenting the coupon at one of the plurality of dispensers at the first fuel dispensing location;
obtaining the discount information from the coupon;
sending the discount information to the local controller;
attempting to communicate with the central system;
in response to said attempting being unsuccessful, checking the local database for the unique discount identifier; and
finding the unique discount identifier in the local database and determining that the status of the coupon is redeemed.

14. The method of claim 13 further including, after the determining step, sending a message to the dispenser to reject the coupon and not to reduce an amount charged to the customer by the discount amount.

15. The method of claim 14 wherein the central system includes a central database, wherein the method further includes communicating with the central system after the central system becomes accessible and adding the identifier associated with the redeemed coupon to the central database.

16. The method of claim 15 wherein the central system is located at a second location remote from the first fuel dispensing location, wherein attempting to communicate includes attempting to communicate through at least one of a network connection and an internet connection.

17. A method of validating a discount offer on a product, comprising:
obtaining discount information from a coupon at a dispenser adapted to dispense the product, the dispenser located at a first location, wherein the discount information includes a unique discount identifier;
sending the discount information to a local controller located at the first location, said local controller adapted to control the dispenser, wherein the local controller includes a local database adapted to store identifiers associated with previously redeemed coupons;
attempting to communicate with a central system to validate the coupon;
in response to said attempting being unsuccessful, comparing the unique discount identifier with the identifiers in the local database; and
in response to the comparing step, sending a message to the dispenser to one of approve and reject the discount offer.

18. The method of claim 17 wherein sending a message to the dispenser comprises sending a message to approve the discount offer, wherein the method further includes adding the unique discount identifier to the local database and associating the identifier with a redeemed status.

19. The method of claim 18 further including, after the step of adding the unique discount identifier to the local database:
presenting the coupon at a dispenser at the first location;
obtaining the discount information from the coupon;
sending the discount information to the local controller;
attempting to communicate with the central system;
in response to said attempting being unsuccessful, checking the local database for the unique discount identifier;
finding the unique discount identifier in the local database and determining that the identifier has a redeemed status; and
sending a message to the dispenser to reject the discount offer.

20. The method of claim 19 wherein the central system includes a central database, wherein the method further includes communicating with the central system after the central system becomes accessible and adding the redeemed identifier to the central database.
